(19) United States
(12) Patent Application Publication
(10) Pub. No.: US 2025/0267593 A1
(43) Pub. Date: Aug. 21, 2025

(54) TRANSMISSION POWER OF CARRIER WAVES FOR AMBIENT INTERNET OF THINGS (AIOT) DEVICES

(71) Applicant: Lenovo (Singapore) Pte. Ltd., Singapore (SG)

(72) Inventors: Ali Ramadan ALI, Kraiburg am Inn (DE); Karthikeyan GANESAN, Nauheim (DE); Hyung-Nam CHOI, Ottobrunn (DE)

(21) Appl. No.: 19/052,785

(22) Filed: Feb. 13, 2025

Related U.S. Application Data
(60) Provisional application No. 63/554,575, filed on Feb. 16, 2024.

(51) Int. Cl. H04W 52/36; H04W 72/231; H04W 76/20

(52) U.S. Cl. CPC H04W 52/367; H04W 72/231; H04W 76/20

(57) ABSTRACT

Various aspects of the present disclosure relate to employing emitter nodes to excite Internet of Things (IoT) devices, such as ambient-powered IoT devices. For example, a base station may configure an emitter node, such as a user equipment (UE), and/or an AIoT device to implement adjustments of a carrier wave transmission power during excitation of the AIoT device by the emitter node.

### CROSS-REFERENCE TO RELATED APPLICATIONS

This application claims priority to U.S. Provisional Patent Application No. 63/554,575, filed on Feb. 16, 2024, entitled CONFIGURING TRANSMISSION POWER OF CARRIER WAVES FOR AMBIENT INTERNET OF THINGS (AIOT) DEVICES, which is hereby incorporated by reference in its entirety.

### TECHNICAL FIELD

The present disclosure relates to wireless communications, and more specifically to configuring transmission power of carrier waves for ambient Internet of Things (AIoT) devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Ambient power-enabled devices, such as ambient Internet of Things (IoT) devices, or AIoT devices, include battery-less devices that have limited storage capabilities (e.g., they store a limited amount of energy using capacitors) or other capability restrictions. These restricted devices may store energy by harvesting energy from the environment of the IoT device, such as via radio waves, light, heat, motion, and other energy/power sources available to the IoT device.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that facilitate the configuration of the transmission power of carrier waves transmitted from emitter nodes (e.g., UEs) to IoT devices, such as ambient-powered IoT devices.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit, to an emitter node, a first configuration associated with adjusting a transmission power for a carrier wave transmission to an IoT device, and transmit, to the IoT device, a second configuration comprising a request for information associated with adjusting the transmission power of the carrier wave transmission.

A method performed or performable by the network entity is described. The method may comprise transmitting, to an emitter node, a first configuration associated with adjusting a transmission power for a carrier wave transmission to an IoT device, and transmitting, to the IoT device, a second configuration comprising a request for information associated with adjusting the transmission power of the carrier wave transmission.

In some implementations of the network entity and method described herein, the network entity and method may further be configured to, capable of, performed, performable, or operable to receive, from the IoT device, via a backscatter transmission, the information for adjusting the transmission power for the carrier wave transmission.

In some implementations of the network entity and method described herein, wherein the first configuration indicates a guard band or a zero power reference signal between the carrier wave transmission and a frequency band, and wherein the at least one processor is further configured to cause the network entity to measure an interference level in the frequency band and adapt a length of the guard band based at least in part on the measured interference level in the frequency band.

In some implementations of the network entity and method described herein, the first configuration indicates a threshold transmission power for the carrier wave transmission.

In some implementations of the network entity and method described herein, the network entity and method may further be configured to, capable of, performed, performable, or operable to transmit the first configuration in a radio resource control (RRC) message.

In some implementations of the network entity and method described herein, the network entity and method may further be configured to, capable of, performed, performable, or operable to transmit the first configuration in a system information block (SIB).

In some implementations of the network entity and method described herein, the first configuration indicates a transmit power command (TPC) for the carrier wave transmission.

In some implementations of the network entity and method described herein, the network entity and method may further be configured to, capable of, performed, performable, or operable to transmit the TPC is transmitted via a downlink control information (DCI) format 2_2.

In some implementations of the network entity and method described herein, the first configuration comprises a TPC index for setting a transmission power of the carrier wave transmission.

In some implementations of the network entity and method described herein, the network entity and method may further be configured to, capable of, performed, performable, or operable to receive a DCI including a single bit field that indicates the first configuration or the transmission power for the carrier wave transmission.

In some implementations of the network entity and method described herein, the network entity and method may further be configured to, capable of, performed, performable, or operable to receive a DCI including a multi-bit field that indicates different transmission powers for the carrier wave transmission.

In some implementations of the network entity and method described herein, the network entity and method may further be configured to, capable of, performed, performable, or operable to transit the first configuration via an F1 or an X2 interface.

In some implementations of the network entity and method described herein, the second configuration comprises a resource allocation or a bit field that indicates to provide assistance information via the backscatter transmission.

In some implementations of the network entity and method described herein, the IoT device is an AIoT device.

An IoT device for wireless communication is described. The IoT device may be configured to, capable of, or operable to perform one or more operations as described herein. For example, the IoT device may comprise at least one memory and at least one processor coupled with the at least one memory and configured to cause the IoT device to receive, from a network entity, a configuration comprising a request for information associated with adjusting transmission power of a carrier wave transmission received from an emitter node, and transmit, to the network entity via a backscatter transmission, the information associated with adjusting transmission power of a carrier wave transmission.

A method performed or performable by the IoT device is described. The method may comprise receiving, from a network entity, a configuration comprising a request for information associated with adjusting transmission power of a carrier wave transmission received from an emitter node, and transmitting, to the network entity via a backscatter transmission, the information associated with adjusting transmission power of a carrier wave transmission.

A processor for wireless communication is described. The processor may be configured to, capable of, or operable to perform one or more operations as described herein. For example, the processor may comprise at least one memory and at least one controller coupled with the at least one memory and configured to cause the processor to receive, from a network entity, a configuration comprising a request for information associated with adjusting transmission power of a carrier wave transmission received from an emitter node, and transmit, to the network entity via a backscatter transmission, the information associated with adjusting transmission power of a carrier wave transmission.

In some implementations of the IoT device, processor, and method described herein, the IoT device, processor, and method may further be configured to, capable of, performed, performable, or operable to receive the carrier wave transmission from the emitter node, and transmit the backscatter transmission in response to the received carrier wave transmission.

In some implementations of the IoT device, processor, and method described herein, the configuration is received via a predefined field configured to the IoT device.

In some implementations of the IoT device, processor, and method described herein, the configuration comprises a threshold level of stored energy associated with adjusting the transmission power of the carrier wave transmission.

In some implementations of the IoT device, processor, and method described herein, the information indicates an intensity level of the carrier wave transmission received from the emitter node.

In some implementations of the IoT device, processor, and method described herein, the IoT device, processor, and method may further be configured to, capable of, performed, performable, or operable to transmit multiple bits to indicate different transmission powers of the carrier wave transmission received from the emitter node.

In some implementations of the IoT device, processor, and method described herein, the IoT device, processor, and method may further be configured to, capable of, performed, performable, or operable to transmit multiple bits to indicate different levels of stored energy at the IoT device.

In some implementations of the IoT device, processor, and method described herein, the IoT device is an AIoT device.

### BRIEF DESCRIPTION OF THE DRAWINGS

FIG. 1 illustrates an example of a wireless communications system in accordance with aspects of the present disclosure.

FIG. 2 illustrates an example topology of a UE acting as an emitter for an AIoT device in accordance with aspects of the present disclosure.

FIG. 3 illustrates an example diagram depicting interference at a base station accordance with aspects of the present disclosure.

FIG. 4 illustrates an example of a messaging flow between devices in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by a NE in accordance with aspects of the present disclosure.

FIG. 9 illustrates a flowchart of a method performed by a UE in accordance with aspects of the present disclosure.

### DETAILED DESCRIPTION

A wireless communication system may include one or more AIoT devices, which may be a passive-IoT device or a passive radio frequency identification (RFID) tag (e.g., sticker, tag, badge, patch, or the like) that supports one or more functionalities at lower cost and maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). The AIoT may perform one or more operations (e.g., transmission, reception, via backscattering) using the stored harvested energy. For example, the AIoT device may be a passive RFID tag equipped on an object or other device enabling for tracking of a location of the object or the other device using stored harvested energy.

An AIoT device may be classified according to one or more categories. A first category AIoT device may lack both energy harvesting capabilities and communication capabilities. As such, the first category AIoT device may be exclusively capable of performing backscattering operations (e.g., backscattering transmissions). A second category AIoT device may support energy harvesting capabilities but lack communication capabilities. As such, the second category AIoT device may be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may support both energy harvesting and communication capabilities. In this example, the third category AIoT device may be equipped with an active radio frequency circuitry to support active communication (e.g., transmission, reception of signals).

In some cases, the wireless communications system may implement various topologies and deployment scenarios, such as one example topology in which a NE (e.g., a base station or other network entity) functions as a reader and a source of a carrier wave (e.g., for exciting an AIoT device to perform backscattering), another example topology in which the NE functions as the reader and a different device (e.g., a UE or other intermediate node) functions as the source of the carrier wave (e.g., an emitter node), another example topology in which the NE controls operations and other network entities (e.g., nodes) function as readers and/or carrier wave sources, and the like.

In some cases, a range or coverage of communications between the NE and the AIoT device can weaken or change based on distance and/or mobility of the devices, as well as due to interference levels at the NE. The NE, therefore, may cause or configure the UE to adjust a transmission power level of a carrier wave transmitted to the AIoT device. Additionally, or alternatively, the NE may transmit, to the AIoT device, a configuration that requests assistance information (e.g., within backscattering transmissions) to assist in determining power adjustments for the carrier wave. Thus, the NE may enable devices to perform operations using suitable or enhanced carrier wave power levels, mitigating issues associated with weak signals and/or interference due to carrier wave signaling, among other benefits.

Aspects of the present disclosure are described in the context of a wireless communications system.

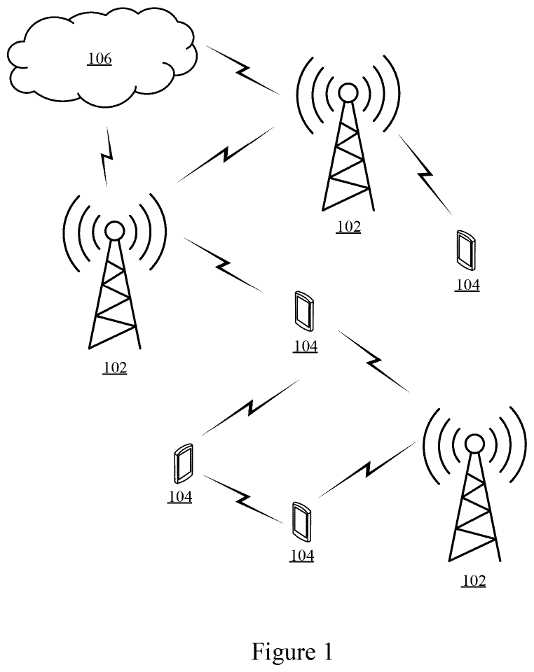

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be example of a UE 140), such as ambient IoT devices. As described herein, an AIoT device may be associated with a low complexity profile (e.g., low power consumption, less capabilities). Unlike other IoT devices defined by 3^{rd} Generation Partnership Project (3GPP), ambient power-enabled devices may exclude a universal subscriber identity module (USIM), and thus may lack components (e.g., circuitry) that can apply security to communications to/from the devices and/or perform signal generation and transmissions.

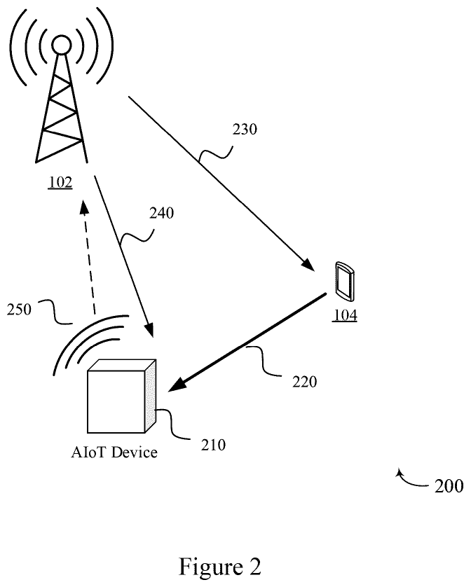

FIG. 2 illustrates an example topology 200 of a UE functioning as an emitter for an AIoT device in accordance with aspects of the present disclosure. The topology 200 includes the NE 102 (e.g., a base station), the UE 104 (e.g., acting as an emitter node), and an AIoT device 210. The UE 104 sends carrier waves 220 to the AIoT device 210, which excite the AIoT device 210, enabling or causing the AIoT device 210 to performing backscattering transmissions 250, which are read by the NE 102 (acting as a reader).

In some cases, a range or coverage of communications between the NE 102 and the AIoT device 210 can weaken or change based on distance and/or mobility, as well as due to interference levels at the NE 102 from in-band backscattering changes. For example, due to path loss and/or attenuation in a channel, and losses at the AIoT device 210, a backscattered signal may weaken as the distance to a target device (e.g., the NE 102) increases and/or the AIoT device 210 is moving. Thus, the mobility and/or relative distances between the AIoT device 210, as well a transmission power for the carrier waves 220, may cause the backscattering changes.

In some embodiments, the NE 102 can configure the UE 104 (or another emitter node, such as a TRP) and/or the AIoT device 210 to implement adjustments of the carrier wave transmission power during excitation of the AIoT device 210. The adjustments to the transmission power of a carrier wave (e.g., the carrier wave 220) may be increased to ensure a reliable backscattering transmission from the AIoT device 210. In some cases, the increase in the transmission power may be balanced or controlled to avoid or reduce interference with adjacent signals in a frequency band. Therefore, a dynamic adaptation/adjustment of carrier wave power may provide an optimized reception of the backscattering while limiting or minimizing any resulting interferences.

For example, a base station (e.g., the NE 102) transmits a configuration to an external emitter (e.g., the UE 104 or another emitter node) to adapt a power level of a carrier wave (e.g., the carrier wave 220) transmitted to the AIoT device 210. In response to the received backscattered signal 250, the base station transmits a configuration (or an updated configuration) to the emitter node to adjust the power level of a next carrier wave transmission.

In some cases, the base station may determine the adjustment of the power level of the carrier wave 220 on an intensity level of the received backscattered signal 250, an interference level, and/or a block error rate of the received backscattered signal 250. For example, the base station can measure the intensity level of the received backscattered signal 250, and when the signal is below a certain threshold, the base station transmits an indication to the UE 104 to increase the transmission power of the carrier wave 220.

The base station may transmit a single bit that indicates to the UE 104 to increase the power level by one increment above a previous value or indicating or to decrease the power level by one increment below the previous value. Further, if the indication is absent a bit, the UE 104 may maintain a current or previously used power value for transmitted carrier waves.

In some cases, the base station may set multiple threshold levels associated with an expected or desirable power of the received backscattering and, accordingly, transmits a power level to the UE 104. For example, the base station may set four threshold values for the received backscattering signal, and upon a received backscattered signal power, the base station transmits two bits to the UE 104 that indicate a desired transmission power level for the carrier wave 220.

In some embodiments, the base station may measure interference levels in the uplink (UL) channels. For example, the base station may measure interference in the band used by the AIoT device 210 for the backscattering 250 via adjacent bands (e.g., NR legacy channel bands). The base station may configure the emitter node (e.g., the UE 104) with zero power bands (e.g., guard bands) or zero power reference signals during transmission of the carrier wave 220.

The emitter node may mute the transmission in a corresponding symbol or resource elements (REs) configured as zero power for the interference measurement. When the measured interference level is above a certain threshold level, the base station sends an indication to the emitter node to reduce the power level of a next transmitted carrier wave. The base station may measure the interference level in a guard band between the carrier wave 220 and the NR legacy channels or between different carrier wave bands.

For example, upon measuring interference levels being above the predefined threshold levels, the base station signals a single bit to the emitter node to decrease the power of the carrier wave transmission. As another example, the base station may send an indication to decrease or increase the transmission power in combination with adapting a length of the guard band between two carrier waves or between the carrier wave 220 and channels adjacent to the carrier wave 220 (e.g., the NR legacy channels). In such cases, the base station may set two or more threshold levels for the interference level, and based on the measured interference level, transmit an indication to the emitter node to decrease or increase the transmission power of the carrier wave 220 and/or decrease or increase the size of the guard band between the carrier wave 220 and other signals.

In some embodiments, the base station may configure the emitter node to adapt the transmission power and direction of a transmission beam used for the carrier wave 220 based on a received backscattering signal level and/or interference level based on the backscattered signal level.

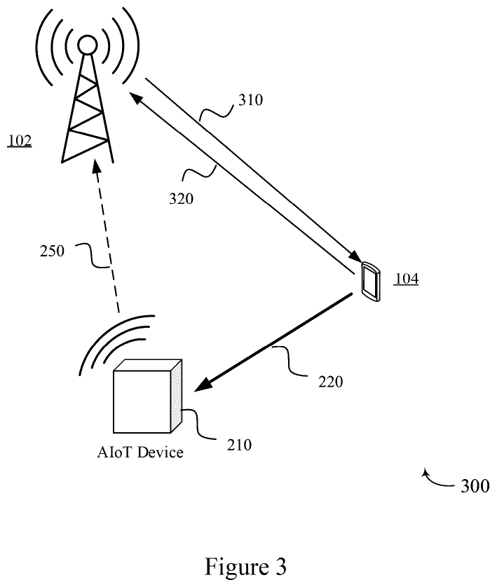

FIG. 3 illustrates an example diagram 300 depicting interference at a base station in accordance with aspects of the present disclosure. The interference at the base station (e.g., the NE 102) may be based on a configuration signal 310 transmitted to the UE 104, direct carrier wave reception 320 at the NE 102, and/or interference between the carrier wave 220 and adjacent UE uplink data. Thus, the interference at the NE 102 may be based on the direct carrier wave reception 320 in addition to the backscattering 250 from the AIoT device 210. The NE 102, as described herein, may cause the UE 104 to adjust the beam and power of the carrier wave 220 to minimize the interference.

In some embodiments, the emitter node (e.g., the UE 104), may be employed to excite multiple AIoT devices. The base station may transmit multiple values for the transmission power of a carrier wave, where each value corresponds to a different AIoT device.

In some embodiments, when multiple beams are used to transmit the carrier wave 220 to the AIoT device 210, the base station may transmit multiple transmission power values that corresponding with each beam used for transmission.

The base station transmits a configuration to the emitter node, where the configuration includes different parameters. For example, when the emitter is the UE 104, the base station may signal the configuration via RRC and/or via UL DCI. The base station may set a maximum allowed power of the carrier wave using SIB messages, such as an FrequencyInfoUL-SIB information element, with an additional power max parameter p-cw-Max being set for the carrier wave 220, as follows:

```
FrequencyInfoUL-SIB ::= SEQUENCE {
  frequencyBandList MultiFrequencyBandListNR-SIB OPTIONAL, -- Cond
FDD-OrSUL
  absolute FrequencyPointA ARFCN-ValueNR OPTIONAL, -- Cond FDD-
OrSUL
  scs-SpecificCarrierList SEQUENCE (SIZE (1..maxSCSs)) OF SCS-SpecificCarrier,
  p-Max P-Max OPTIONAL, -- Need S
  p-cw-Max INTEGER (1, 2, ..)
  frequencyShift7p5khz ENUMERATED {true} OPTIONAL, -- Cond FDD-
OrSUL-Optional
  ...
}
```

The base station may also transmit the parameters in a PUSCH-PowerControl information element using a dedicated RRC message.

In some cases, the base station may signal a TPC command specific to the carrier wave 220. The UE is (pre-) configured with a table of carrier wave TPC indices. The base station can add parameters used for defining the power, such as the tpc-cw-Accumulation, to PUSCH-PowerControl, and an indication of the TPC command field/index is signaled in UL DCI (e.g., DCI format 2_2). The emitter node may map the TPC command field with the configuration of carrier wave specific parameters, such as tpc-cw-Accumulation, p0-cw-NominalWithGrant, p0-cw-AlphaSets, and so on, signaled in SIB to set (or convert) the transmission power of the carrier wave 220.

In some embodiments, the configuration of the transmission power of the carrier wave 220 may depend on the capability of the emitter node to increase the transmission power. The emitter node, such as the UE 104, may indicate its capability to increase the transmission power based on its power status. The emitter node may be configured to signal a carrier wave power headroom report (PHR) before adjusting the transmission power of the carrier wave 220.

In some embodiments, the base station may signal the configuration for adjusting the power of the carrier wave 220 to the emitter node using an F1 or X2 interface when the emitter node is a TRP within a network.

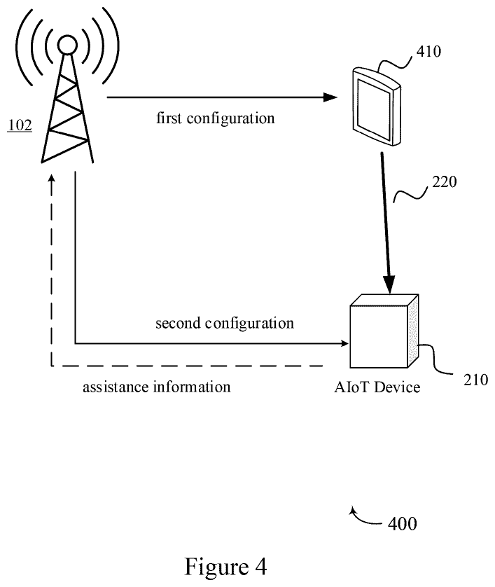

In some embodiments, the base station may configure the AIoT device 210 to send information (e.g., assistance information) to the base station to assist the base station in adjusting the transmission power of the carrier wave 220. FIG. 4 illustrates an example of a messaging flow 400 between devices in accordance with aspects of the present disclosure.

The NE 102 sends a first configuration, as described herein, to an emitter node 410, which causes the emitter node 410 to adjust a transmission power of the carrier wave 220 sent to the AIoT device 210. The NE 102 also sends a configuration (e.g., a second configuration) to the AIoT device 210 to send assistance information for adjusting the power of the carrier wave 220.

For example, in a downlink (DL) signal to the AIoT device 210, the NE 102 may send the configuration to signal assistance information to adjust the carrier wave 220 transmitted by the emitter node 410. This control information may be sent in a predefined field in the DL signal that is known to the AIoT device 210. This configuration may contain a configuration for resources/bit field in the backscattered information 250 to indicate to the NE 102 the information for assisting in the power adjustment of the carrier wave 220.

The backscattered information 250 may contain one or more bits from the AIoT device 210. The AIoT device 210 may measure the intensity/power of the received carrier wave 220. When the received intensity/power of the carrier wave 220 is below a certain threshold, the AIoT device 210 adds information in the configured field within the backscattered signal 250 to indicate an adjustment (or request to for adjustment) of the transmission power.

In some cases, the request to adjust the power may be based on a level of stored energy in the AIoT device 210. The AIoT device 310 may request to increase the transmission power of the carrier wave 220 when its stored energy is reduced below a certain threshold. For example, the AIoT device 210 may be configured to signal two bits of information to indicate an increment or decrement of the carrier wave transmission power. The increment or decrement may include various levels, such as a one-step increment, a two-step increment, a one-step decrement, a two-step decrement, and so on.

Thus, the bits may indicate the level of the carrier wave transmission power adjustment from a previous or most recent value. The AIoT device 210 may be configured to signal the level of its stored energy (e.g., where two bits indicates four levels of the stored energy). Further, the AIoT device 210 may indicate an intensity level of the incident carrier wave 220 (e.g., where two bits is sent to indicate four different levels of the received power/intensity of the carrier wave 220).

Thus, in various embodiments, the technology described herein may perform various methods for configuring an emitter node (e.g., the UE 104 or a TRP) to adjust the transmission of a carrier wave sent to an IoT device, such as an ambient-powered IoT device.

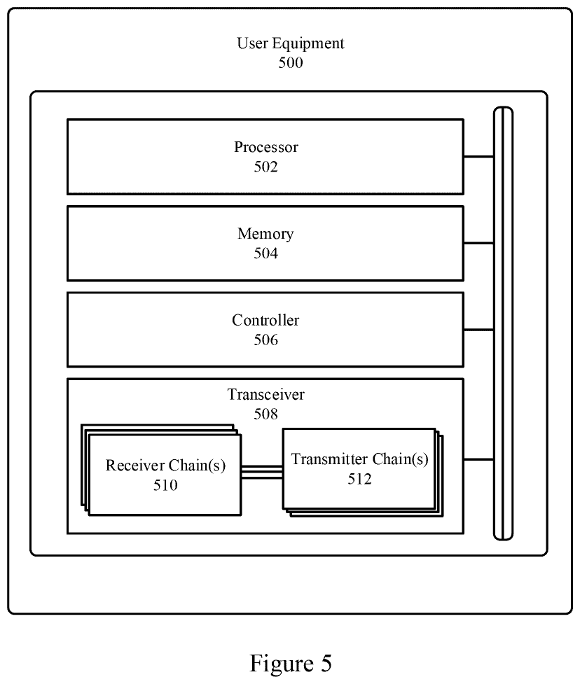

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for receiving, from a network entity, a configuration comprising a request for information associated with adjusting transmission power of a carrier wave transmission received from an emitter node and transmitting, to the network entity via a backscatter transmission, the information associated with adjusting transmission power of a carrier wave transmission.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

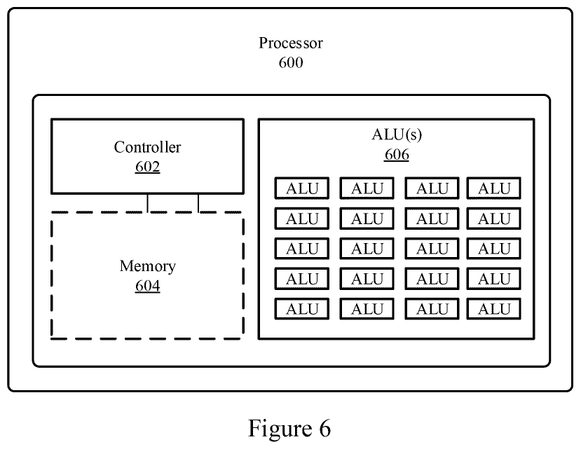

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The UE processor 600 may be configured to support a means for receiving, from a network entity, a configuration comprising a request for information associated with adjusting transmission power of a carrier wave transmission received from an emitter node and transmitting, to the network entity via a backscatter transmission, the information associated with adjusting transmission power of a carrier wave transmission.

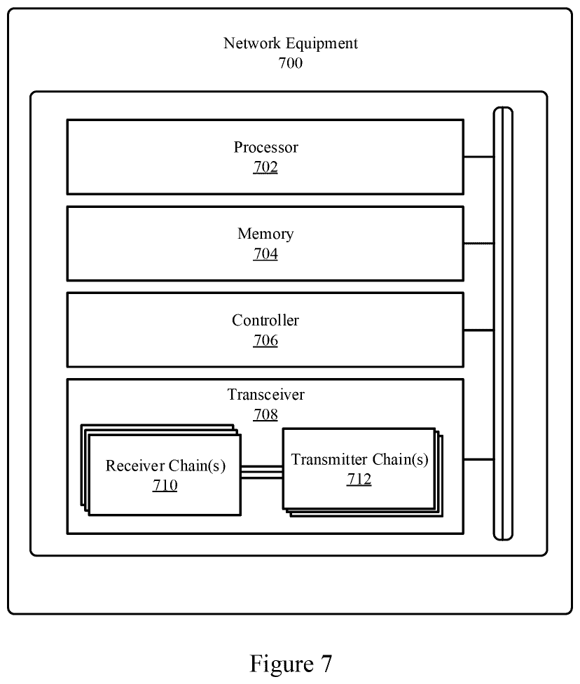

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for transmitting, to an emitter node, a first configuration associated with a transmission power for a carrier wave transmission sent to an IoT device, and transmitting, to the IoT device, a second configuration comprising a request for information for adjusting the transmission power for the carrier wave transmission.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

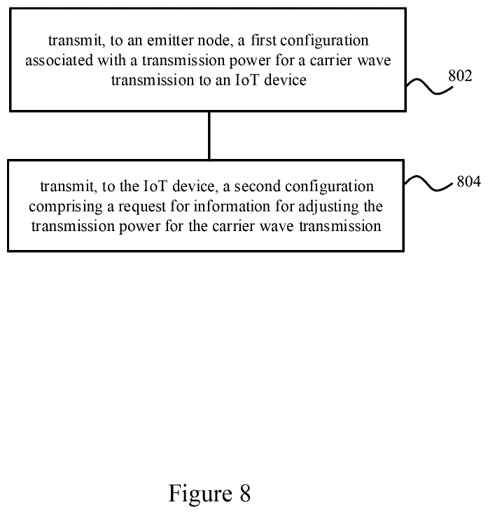

FIG. 8 illustrates a flowchart of a method in accordance with aspects of the present disclosure. The operations of the method may be implemented by a NE as described herein. In some implementations, the NE may execute a set of instructions to control the function elements of the NE to perform the described functions.

At 802, the method may include transmitting, to an emitter node, a first configuration associated with a transmission power for a carrier wave transmission to an IoT device. The operations of 802 may be performed in accordance with examples as described herein. In some implementations, aspects of the operations of 802 may be performed by a NE as described with reference to FIG. 7.

At 804, the method may include transmitting, to the IoT device, a second configuration comprising a request for information for adjusting the transmission power for the carrier wave transmission. The operations of 804 may be performed in accordance with examples as described herein. In some implementations, aspects of the operations of 804 may be performed by a NE as described with reference to FIG. 8.

It should be noted that the method described herein describes a possible implementation, and that the operations and the steps may be rearranged or otherwise modified and that other implementations are possible.

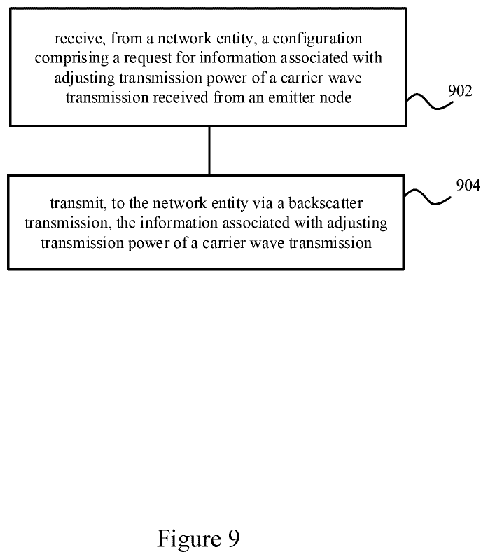

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving, from a network entity, a configuration comprising a request for information associated with adjusting transmission power of a carrier wave received from an emitter node. The operations of 902 may be performed in accordance with examples as described herein. In some implementations, aspects of the operations of 902 may be performed by a UE as described with reference to FIG. 5.

At 904, the method may include transmitting, to the network entity via backscatter transmission, the information associated with adjusting transmission power of a carrier wave transmission. The operations of 904 may be performed in accordance with examples as described herein. In some implementations, aspects of the operations of 904 may be performed by a UE as described with reference to FIG. 5.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
transmit, to an emitter node, a first configuration associated with a transmission power for a carrier wave transmission to an Internet of Things (IoT) device; and
transmit, to the IoT device, a second configuration comprising a request for information for adjusting the transmission power for the carrier wave transmission.

2. The network entity of claim 1, wherein the at least one processor is further configured to cause the network entity to:
receive, from the IoT device, via a backscatter transmission, the information for adjusting the transmission power for the carrier wave transmission.

3. The network entity of claim 1, wherein the first configuration indicates a guard band or a zero power reference signal between the carrier wave transmission and a frequency band, and wherein the at least one processor is further configured to cause the network entity to:
measure an interference level in the frequency band; and
adapt a length of the guard band based at least in part on the measured interference level in the frequency band.

4. The network entity of claim 1, wherein the first configuration indicates a threshold transmission power for the carrier wave transmission.

5. The network entity of claim 4, wherein the at least one processor is further configured to cause the network entity to transmit the first configuration in a radio resource control (RRC) message.

6. The network entity of claim 4, wherein the at least one processor is further configured to cause the network entity to transmit the first configuration in a system information block (SIB).

7. The network entity of claim 1, wherein the first configuration indicates a transmit power command (TPC) for the carrier wave transmission.

8. The network entity of claim 7, wherein the at least one processor is further configured to cause the network entity to transmit the TPC via a downlink control information (DCI) format 2_2.

9. The network entity of claim 7, wherein the first configuration comprises a TPC index for setting a transmission power of the carrier wave transmission.

10. The network entity of claim 1, wherein the at least one processor is further configured to cause the network entity to receive a downlink control information (DCI), including a single bit field that indicates the first configuration or the transmission power for the carrier wave transmission.

11. The network entity of claim 1, wherein the at least one processor is further configured to cause the network entity to receive a downlink control information (DCI), including a multi-bit field that indicates different transmission powers for the carrier wave transmission.

12. The network entity of claim 1, wherein the at least one processor is further configured to cause the network entity to transit the first configuration via an F1 or an X2 interface.

13. The network entity of claim 1, wherein the second configuration comprises a resource allocation or a bit field that indicates to provide assistance information via the backscatter transmission.

14. A method performed by a network entity, the method comprising:
transmitting, to an emitter node, a first configuration associated with a transmission power for a carrier wave transmission to an Internet of Things (IoT) device; and
transmitting, to the IoT device, a second configuration comprising a request for information for adjusting the transmission power for the carrier wave transmission.

15. An Internet of Things (IoT) device for wireless communication, comprising:
at least one memory; and
at least one processor coupled with the at least one memory and configured to cause the IoT device to:
receive, from a network entity, a configuration comprising a request for information associated with adjusting transmission power of a carrier wave transmission received from an emitter node; and
transmit, to the network entity via a backscatter transmission, the information associated with adjusting transmission power of a carrier wave transmission.

16. The IoT device of claim 15, wherein the at least one processor is further configured to cause the IoT device to:
receive the carrier wave transmission from the emitter node; and
transmit the backscatter transmission in response to the received carrier wave transmission.

17. The IoT device of claim 15, wherein the configuration comprises a threshold level of stored energy associated with adjusting the transmission power of the carrier wave transmission.

18. The IoT device of claim 15, wherein the at least one processor is configured to cause the IoT device to transmit multiple bits to indicate different transmission powers of the carrier wave transmission received from the emitter node.

19. The IoT device of claim 15, wherein the at least one processor is configured to cause the IoT device to transmit multiple bits to indicate different levels of stored energy at the IoT device.

20. A method performed by an Internet of Things (IoT) device, the method comprising:
receiving, from a network entity, a configuration comprising a request for information associated with adjusting transmission power of a carrier wave transmission received from an emitter node; and
transmitting, to the network entity via a backscatter transmission, the information associated with adjusting transmission power of a carrier wave transmission.
